(19) United States
(12) Patent Application Publication
(10) Pub. No.: US 2007/0005982 A1
(43) Pub. Date: Jan. 4, 2007

(54) Communication apparatus and communication method

(75) Inventor: Hirotsugu Kato, Konosu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/475,866

(22) Filed: Jun. 28, 2006

(30) Foreign Application Priority Data
Jun. 30, 2005 (JP) 2005-192695

(51) Int. Cl. H04L 9/00

(52) U.S. Cl. 713/176

(57) ABSTRACT

According to one embodiment, there is provided a communication apparatus has a communication unit which makes a communication via a network, a database unit which stores route certificate data, a control unit which makes a control to supply address information of a server device that manages content, a command to process the content, the route certificate data for verifying server certificate data of the server device to an external device on the network via the communication unit.

### CROSS-REFERENCE TO RELATED APPLICATIONS

This application is based upon and claims the benefit of priority from Japanese Patent Application No. 2005-192695, filed Jun. 30, 2005, the entire contents of which are incorporated herein by reference.

### BACKGROUND

1. Field

One embodiment of the invention relates to communication apparatuses between networks, and in particular, to communication apparatuses and a communication method which acquire contents from a server device on the Internet and process the acquired contents.

2. Description of the Related Art

Recently, network technology has been remarkably popularized, and apparatuses in which authentication processing and determination processing are performed among a plurality of communication apparatuses are known.

The invention in Patent Document 1 (Jpn. Pat. Appln. KOKAI Publication No. 2003-208406) is a remote control device and a remote control system for receiving a command from a user via a communication line, accessing a communication equipment control device provided in a living space via a communication line (Internet or the like), and causing the communication equipment control device to make a control corresponding to a content of the command from the user. The remote control device and remote control system each have a user access function of accessing a user, an authentication function of authenticating a user, and a communication equipment control device access function of accessing a communication equipment control device.

In the system in Patent Document 1, however, there is the problem that, when an attempt is made to cause a communication apparatus having no route certificate required by an opponent party to acquire contents on a web server on, for example, the Internet and print it, it is not obvious how to provide a route certificate, and how to make authentication processing for a server certificate of a server device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a configuration of communication apparatuses according to one embodiment of the present invention;

FIG. 2 is a block diagram showing one example of a detailed configuration of the communication apparatuses according to the embodiment of the invention;

FIG. 3 is a flowchart showing one example of first URL print processing of the communication apparatuses according to the embodiment of the invention;

FIG. 4 is a flowchart showing one example of second URL print processing of the communication apparatuses according to the embodiment of the invention;

FIG. 5 is a flowchart showing one example of third URL print processing of the communication apparatuses according to the embodiment of the invention;

FIG. 6 is a flowchart showing one example of fourth URL print processing of the communication apparatuses according to the embodiment of the invention; and

FIG. 7 is a system diagram showing one example of LAN which is formed by the communication apparatuses according to the embodiment of the present invention.

### DETAILED DESCRIPTION

Various embodiments according to the invention will be described hereinafter with reference to the accompanying drawings. In general, according to one embodiment of the invention, a communication apparatus comprises a communication unit which makes a communication via a network; a database unit which stores route certificate data; a processing unit which supplies address information of a server device that manages content, a command to process the content, the route certificate data for verifying server certificate data of the server device to an external device on the network via the communication unit.

Among the communication apparatuses described above, the communication apparatus having route certificate data can cause the communication apparatus having no route certificate data to acquire content on a web server on the Internet and process the acquired content.

Hereinafter, the embodiment of the present invention will be described in detail with reference to the drawings.

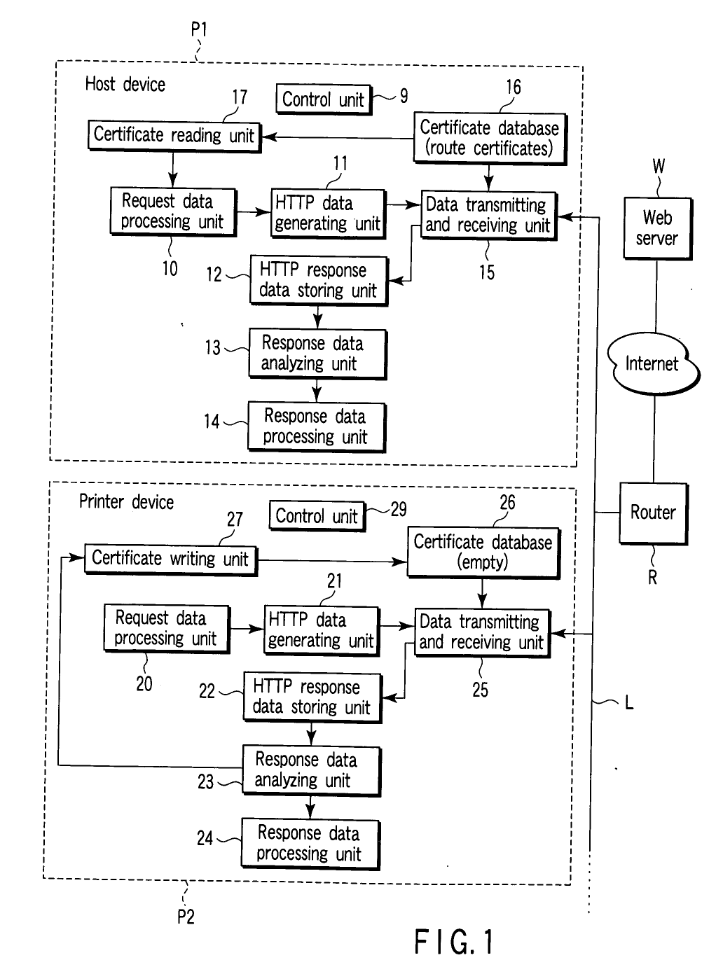

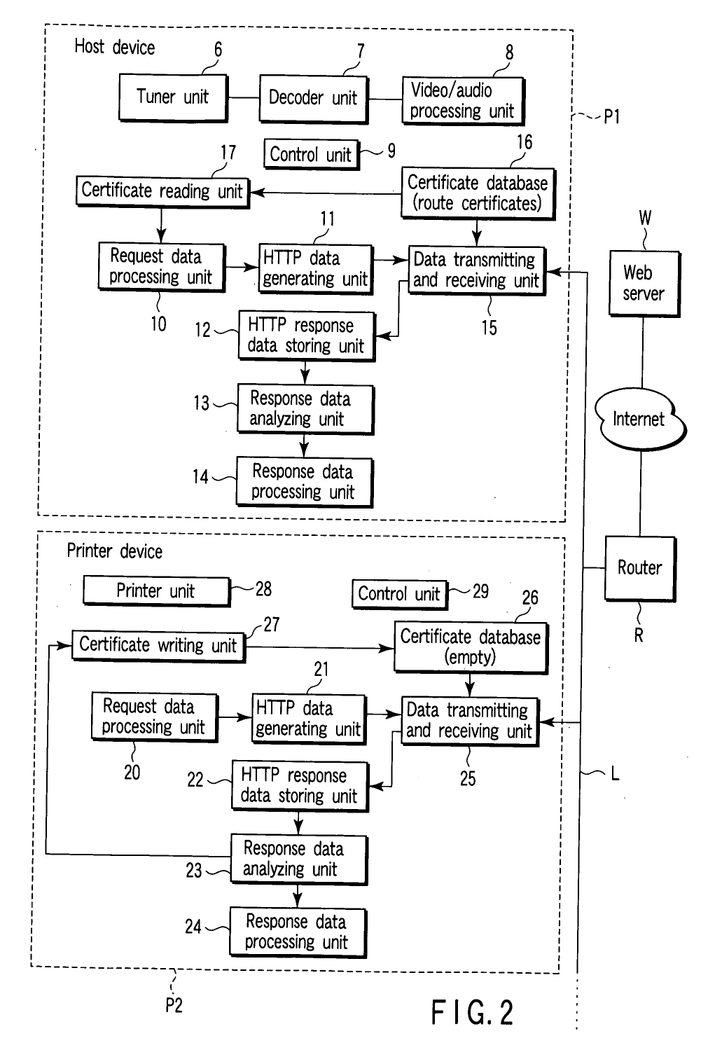

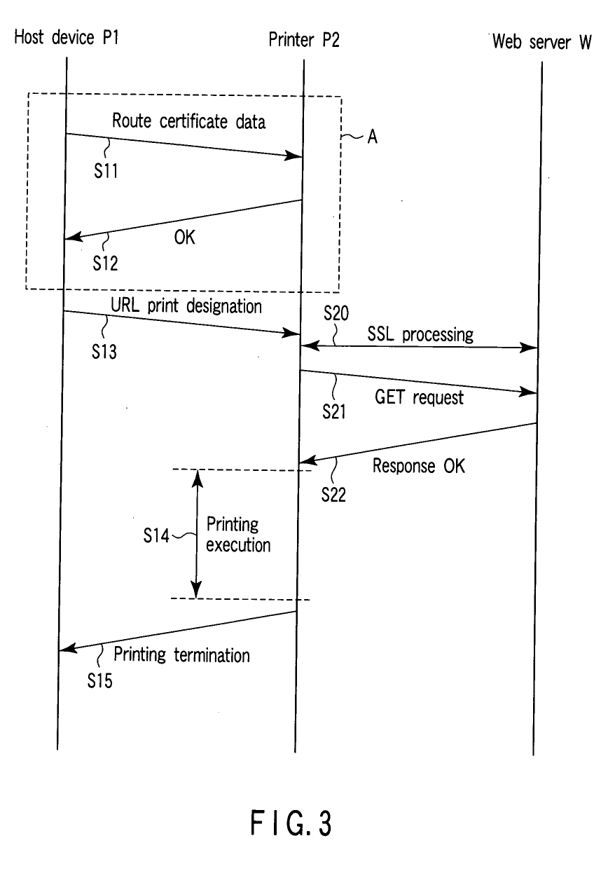

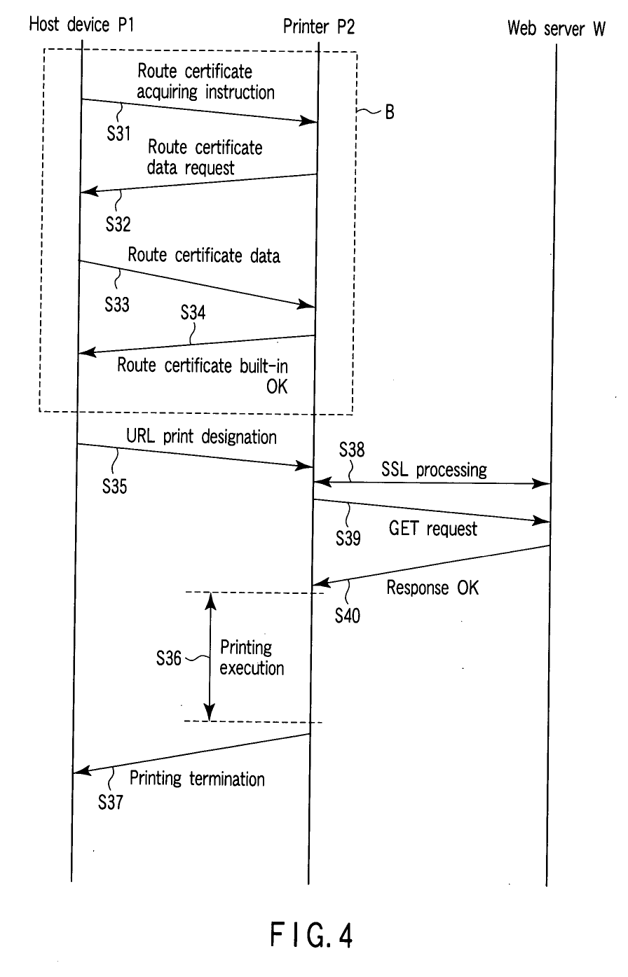

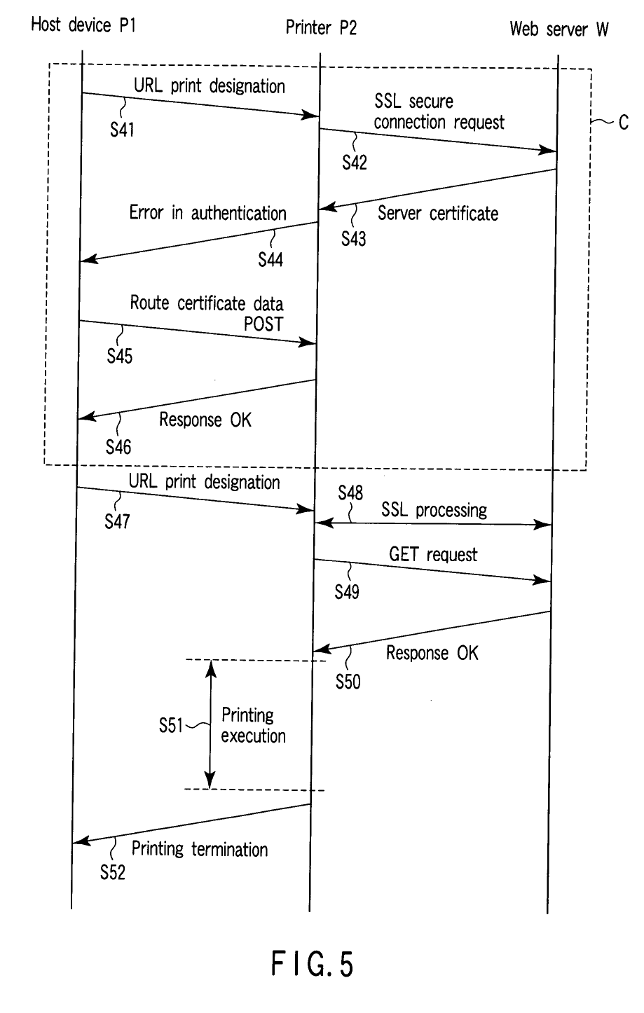

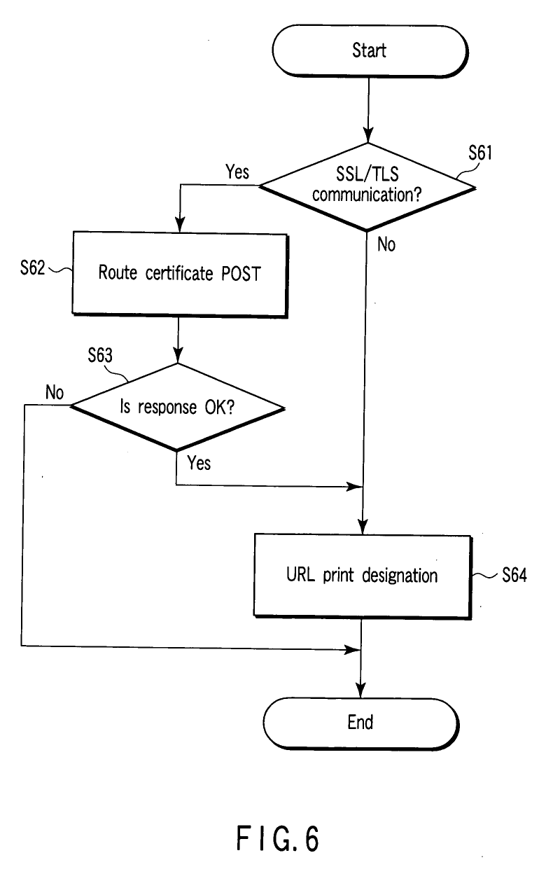

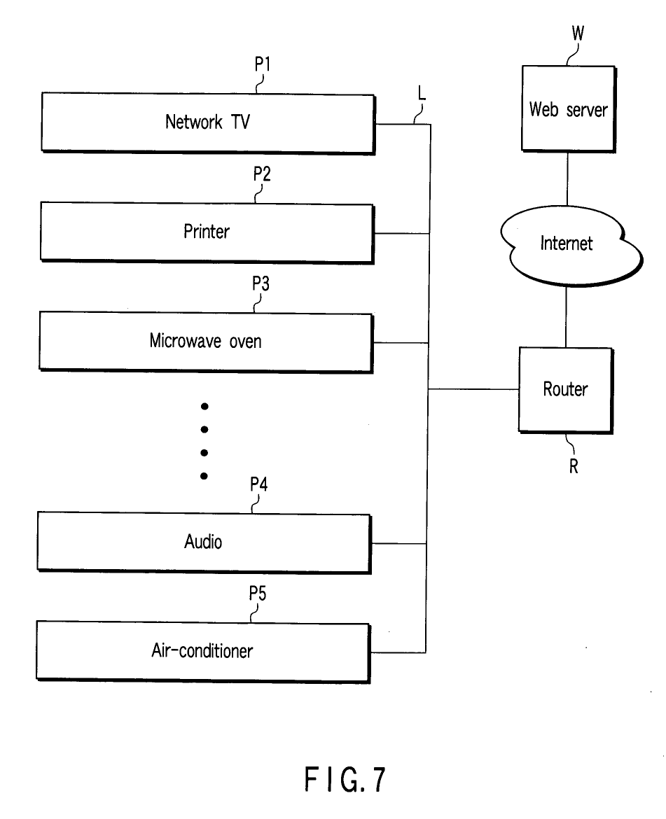

FIG. 1 is a block diagram showing one example of a configuration of communication apparatuses according to one embodiment of the present invention. FIG. 2 is a block diagram showing one example of a detailed configuration of the communication apparatuses. FIG. 3 is a flowchart showing one example of first URL print processing of the communication apparatuses. FIG. 4 is a flowchart showing one example of second URL print processing of the communication apparatuses. FIG. 5 is a flowchart showing one example of third URL print processing of the communication apparatuses. FIG. 6 is a flowchart showing one example of fourth URL print processing of the communication apparatuses. Since the following flowchart can be made of circuit blocks, each step of the flowchart can be defined as a block. FIG. 7 is a system diagram showing one example of a LAN which is formed by the communication apparatuses.

<Host Device and Printer Device>

Between the communication apparatuses (a host device and a printer device) according to one embodiment of the invention, as one example, route certificate data is supplied from a host device P1 having the route certificate data to a printer device P2 having no necessary route certificate data via a LAN or the like. As a consequence, by merely giving “a command to acquire desired content from a web server, and to process (for example, print) it” from the host device P1 to the printer device P2, it is possible for the printer device P2 alone to determine server certificate data by using route certificate data, and to acquire content and process (print) the content.

It is assumed that, among a plurality of home network devices which are remote-controlled by each other, one home network device gives another home network device an instruction of secure communication connection with a web server on the Internet. In this case, in addition to the instruction data, a route certificate for use in server authentication of the web server to be connected is transmitted, and the home network device on the side to receive the instruction takes in the transmitted route certificate. This enables an access to the web server by secure communication corresponding to server authentication even if the home network device does not have the route certificate in advance.

(Configuration)

The communication apparatuses (the host device and the printer device) according to one embodiment of the invention are, as shown in FIGS. 1 and 2, connected with each other via a network line L such as, for example, a local area network (LAN).

Here, in FIGS. 1 and 2, the host device P1 has a request data processing unit 10, an HTTP data generating unit 11, an HTTP response data storing unit 12, a response data analyzing unit 13, a response data processing unit 14, a data transmitting and receiving unit 15, a certificate database 16 in which a plurality of route certificates are stored in advance, and a certificate reading unit 17. Moreover, the host device P1 is, as one example, a network television device, and has a tuner unit 6, a decoder unit 7, a video/audio processing unit 8 as shown in FIG. 2, and a control unit 9 which controls entire operations.

On the other hand, the printer device P2 (which is not limited to the printer device, and is preferably various application devices as will be described later in FIG. 7) has a request data processing unit 20, an HTTP data generating unit 21, an HTTP response data storing unit 22, a response data analyzing unit 23, a response data processing unit 24, a data transmitting and receiving unit 25, a certificate database 26, a certificate writing unit 27, a printer unit 28 having a printer function, and a control unit 29 which controls entire operations.

Further, a router R is connected to the network line L, and it is possible to makes a communication with a web server device W on the Internet.

<Transfer and Print Processing for Route Certificate Data>

Next, transfer processing and print processing for route certificate data between the host device P1 and the printer device P2 described above will be described in detail with reference to the flowcharts of FIGS. 3 and 6 in accordance with the device configuration of the block diagram in FIG. 2.

First, transfer processing and print processing for route certificate data will be described in accordance with the configurations of the host device P1 and the printer device P2. When the host device P1 accesses the web server device W on the Internet, request data with respect to the web server device W is prepared in the request data processing unit 10. HTTP request data is generated in the HTTP data generating unit 11 on the basis of the request data, and an HTTP request is issued to a web server URL on the Internet via the home network L from the data transmitting and receiving unit 15. Then, an HTTP response from the web server device W is received at the data transmitting and receiving unit 15, and the received response is analyzed in the response data analyzing unit 13 via the response data storing unit 12, and is processed in the response data processing unit 14.

Here, when an HTTP request according to SSL/TLS secure communication protocol is issued to the web server device W on the Internet, an SSL communication connection request is transmitted from the data transmitting and receiving unit 15 to the web server device W. Then, a server certificate transmitted as a response to the SSL communication connection request from the web server device W is received at the data transmitting and receiving unit 15, a route certificate is read out of the certificate database 16, and server authentication of the web server device W is carried out by using this route certificate. When it is confirmed that the web server device W is authentic, an HTTP request is issued from the data transmitting and receiving unit 15, and an HTTP response from the web server device W is received at the data transmitting and receiving unit 15. Then, the received HTTP response is stored in the HTTP response data storing unit 12, and the stored response is analyzed in the response data analyzing unit 13, and is processed in the response data processing unit 14.

Note that one or more route certificates are built into the certificate database 16. However, a route certificate issued by an issuer described in the transmitted server certificate must be built into the certificate database 16 in order to make server authentication a success. When it is successful in accessing the secure web server device W and acquiring content, and the printer device P2 is caused to acquire the content of the secure web server device W and print it, all the certificate data or one item of route certificate data used for the above-described server authentication of the secure web server device W are read out of the certificate database 16 by the certificate reading unit 17. The read data are processed into request data by adding remote control data for the printer device P2 in the request data processing unit 10. HTTP request data is generated in the HTTP data generating unit 11 on the basis of the processed data, and is transmitted to the printer device P2 via the home network L from the data transmitting and receiving unit 15, as remote control data for making an instruction of certificate built-in.

In the printer device P2, HTTP remote control data including the above route certificate data is received at the data transmitting and receiving unit 25, and is stored in the HTTP response data storing unit 22. Then, the HTTP response data is analyzed in the response data analyzing unit 23, and the route certificate data is written into the certificate database 26 via the certificate writing unit 27. The other response data are processed in the response data processing unit 24, and an access is made to a designated secure web server device W by analyzing the remote control data. Then, it is recognized that it is instructed to acquire content from the secure web server device W and to print the content.

When the printer device P2 accesses the secure web server device W on the Internet in accordance with the above-described content acquiring and printing instruction, an SSL communication connection request is transmitted to the secure web server device W, a server certificate transmitted as a response thereto from the web server device W is received at the data transmitting and receiving unit 25, and server authentication of the secure web server device W is carried out by using a route certificate read out of the certificate database 26. When it is confirmed that the web server device W is authentic, HTTP request data is generated in the HTTP data generating unit 21 on the basis of the aforementioned request data with respect to the secure web server device W, the request data being output from the request data processing unit 20. Then, the HTTP request data is issued to a secure web server URL on the Internet via the home network L from the data transmitting and receiving unit 25, and an HTTP response from the web server device W is received at the data transmitting and receiving unit 25, and is stored in the HTTP response data storing unit 22. The HTTP response data is analyzed in the response data analyzing unit 23, and is processed in the response data processing unit 24, and the content included in the HTTP response is printed on a recording medium by use of the printer unit 28. Note that, the certificate database 26 does not always have to retain data, and when an access to a corresponding secure web server device W is completed, route certificate data may be deleted.

(A Case of Transferring Route Certificate Data First: FIG. 3)

Next, the same transfer and print processing for route certificate data will be described hereinafter with reference to the flowchart of FIG. 3. In the flowchart of FIG. 3, the processing will be described with a focus on exchanging data among the host device P1, the printer device P2, and the web server device W of the embodiment.

In this case, route certificate data is first transmitted from the host device P1 to the printer device P2.

Namely, certificate built-in instruction remote control data and route certificate data including a route certificate to be used at the time of accessing the secure web server device W are transmitted by using, for example, a POST command from the host device P1 to the printer device P2 (step S11). When the printer device P2 is successful in acquiring the route certificate data, it responds OK (step S12). At this time, the route certificate data to be transmitted may be all the route certificate data retained by the host device P1, or may be only route certificate data by which a server certificate of a secure web server device W desired to be accessed by the printer device P2 can be verified. In order to qualify a route certificate by which a server certificate of a secure web server device W desired to be accessed can be verified, the host device P1 accesses a corresponding secure web server device W in advance prior to route certificate data built-in processing A, and confirms server authentication, which makes it obvious that the route certificate used for the server authentication is a route certificate corresponding to the server certificate.

After the above route certificate data built-in processing A is completed, the host device P1 transmits URL print designating remote control data for instructions to acquire and print content on a designated secure web server device W (step S13). The printer device P2 carries out SSL server authentication of a web server device W by using the route certificate data transmitted previously from the host device P1 (step S20). When it is confirmed that the web server device W is authentic, an HTTP GET request is issued to the web server device W designated by the URL print designating remote control data (step S21). In contrast thereto, the web server device W returns an HTTP response including a required content to the printer device P2 (step S22). The printer device P2 executes printing of the received content (step S14), and gives notice of termination of printing to the host device P1 (step S15).

As described above, on the basis of the instruction and the route certificate data from the host device P1, the printer device P2 can acquire the content on the secure web server device W and print the content.

(A Case of Transferring Instruction to Acquire Route Certificate Data First: FIG. 4)

Next, “A case of transmitting an instruction to acquire route certificate data first from the host device P1 to the printer device P2” will be described with reference to the flowchart of FIG. 4. Namely, in the case of FIG. 3, the route certificate data is transmitted from the host device P1 by using a POST command. In this case, however, the host device P1 urges the printer device P2 to transmit a GET command.

In the flowchart of FIG. 4, an instruction to acquire certificate is transmitted as remote control data from the host device P1 to the printer device P2 (step S31). The printer device P2 transmits an HTTP GET certificate data request to the host device P1 in accordance with the aforementioned instruction to acquire certificate (step S32). Next, route certificate data is responded as an HTTP response from the host device P1 (step S33). When the printer device P2 is successful in acquiring the route certificate data, the printer device P2 transmits route certificate data built-in termination notifying data to the host device P1 (step S34).

After the above route certificate data built-in instructing processing B is completed, the host device P1 transmits URL print designating remote control data for instructing to acquire and print content on a designated secure web server device W (step S35). The printer device P2 carries out SSL server authentication of the web server device W by using the route certificate data transmitted previously from the host device P1 (step S38). When it is confirmed that the web server device W is authentic, an HTTP GET request is issued to the web server device W designated by the URL print designating remote control data (step S39). In contrast thereto, the web server device W returns an HTTP response including a required content to the printer device P2 (step S40). The printer device P2 executes printing of the received content (step S36), and gives notice of termination of printing to the host device P1 (step S37).

As described above, on the basis of the instruction and the route certificate data from the host device P1, the printer device P2 can acquire and print the content on the secure web server device W.

In the embodiment in FIG. 4, the host device P1 urges the printer device P2 to use a GET command, which makes more certain of transmitting and receiving operations.

(A Case of Transferring Instruction to Print URL First: FIG. 5)

Next, “A case of transmitting an instruction to print URL first from the host device P1 to the printer device P2” will be described with reference to the flowchart of FIG. 5. Here, route certificate data is not transmitted first, and after an error occurs in SSL authentication, route certificate data is transmitted.

In the flowchart of FIG. 5, the host device P1 transmits to the printer device P2 URL print designating remote control data for instructing to acquire content on a secure web server device W to be designated, and to print the content (step S41). The printer device P2 issues an SSL secure connection request according to SSL to a secure web server device W designated by the URL print designating remote control data (step S42). The secure web server device W transmits a server certificate to the printer device P2, and carries out authentication processing (step S43). Here, when the printer device P2 does not have a route certificate for verifying the server certificate, the printer device P2 notifies the host device P1 that an error has occurred in server authentication because there is no route certificate (step S44).

When the host server P1 recognizes the error in server authentication, the host server P1 transmits to the printer device P2 route certificate data to be used at the time of accessing the secure web server device W along with the certificate built-in instruction remote control data (step S45). When the printer device P2 is successful in acquiring the route certificate data, the printer device P2 responds OK (step S46). At this time, the route certificate data to be transmitted may be all the route certificate data retained by the host device P1, or may be only route certificate data for use in server authentication of a secure web server device W desired to be accessed by the printer device P2. In order to qualify a route certificate which can be used for server authentication of a secure web server device W desired to be accessed, the host device P1 accesses a corresponding secure web server device W in advance prior to route certificate data built-in processing, and carries out server authentication. Consequently, it is obvious that the route certificate used at that time is a route certificate corresponding to the server certificate of the corresponding secure web server device W.

After the above route certificate data built-in instructing processing C is completed, the host device P1 transmits URL print designating remote control data for instructing to acquire and print content on a secure web server device W to be designated (step S47). The printer device P2 carries out SSL authentication processing by using the route certificate data (step S48), and thereafter, an HTTP GET request is issued to the web server device W designated by the URL print designating remote control data (step S49). Then, the web server device W returns an HTTP response including required content to the printer device P2 (step S50). The printer device P2 executes printing of the received content (step S51), and gives notice of termination of printing to the host device P1 (step S52).

As described above, on the basis of the instruction from the host device P1, the printer device P2 can acquire and print the content on the secure web server device W. In this case, because the route certificate data is not transmitted first, but is transmitted after really needed, unnecessary route certificate data is not transmitted many times.

(A Case of Transferring Route Certificate Data after Confirming Secure Communication: FIG. 6)

Next, “A case of transferring route certificate data after confirming secure communication” will be described with reference to the flowchart of FIG. 6. Here, after it is confirmed whether the server device W requires secure communication or not, route certificate data is transmitted.

More specifically, in the flowchart of FIG. 6, the host device P1 determined whether or not the web server device W requires secure (SSL/TLS) communication in accordance with whether an URL to be designated starts with https or not when the host device P1 gives an instruction to print the URL to the printer device P2 due to an operation of the control unit 9 (step S61). When the web server device W is not a secure web server device W, an instruction to print the URL is given to the printer device P2 (step S64).

When the web server device W is a secure web server device W, on the other hand, a route certificate necessary for server authentication of a web server device W to be designated is transmitted to the printer device P2 (step S62), and a response from the printer device P2 is confirmed. When the built-in is completed in the printer device P2, a response OK is replied (step S63), and an instruction to print the URL is given to the printer device P2 (step S64). When the built-in is failed in the printer device P2, a response error is replied (step S63), and therefore, an instruction to print the URL is not given. Note that the processing of the flowchart in FIG. 6 can be used together with that in FIGS. 3 to 5, and processing of transferring unnecessary route certificate can be omitted by confirming whether secure communication is required or not.

<Other Communication Devices>

In the communication apparatuses according to the embodiment of the invention, one embodiment relating to a printer has been described. However, the communication apparatuses according to the embodiment of the invention are not limited to a printer in the range of implementation thereof as long as they are controlled via a network and carry out desired information processing.

In FIG. 7, an example of communication apparatuses having various functions is shown. In this case, not only the network television P1 and the printer device P2 on the network L, but also, for example, a home electrical device such as a microwave oven P3, an audio device P4, an air-conditioning device P5, and the like are suitable for use in the same purpose. In other words, among the recent network equipments, it is beneficial to acquire various formed content from a web server device W or the like on an external network such as the Internet. For example, it is effective for the microwave oven P3 to download specific recipe information to use, and further, it is effective for the audio device P4 to download music content to use. Moreover, with respect to also home electrical appliances such as the air-conditioning device P5, an application in which a program for improving operational defects is downloaded or the like is available.

Accordingly, it is extremely of great significance, as the communication system of the present invention, to automatically access the Internet with ease to download necessary data by merely receiving an instruction command from a device having a host function such as a personal computer and a television even if route certificate data is not provided.

Note that, in the above-described embodiment, the communication protocol has been described by using HTTP. However, in the embodiment of the invention, the same operational effects can be brought about by the same processing according to not only this communication protocol, but also another communication protocol.

In accordance with the various embodiments described above, those skilled in the art can realize the present invention. It is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication unit which makes communication via a network;
a database unit which stores route certificate data;
a processing unit which supplies address information of a server device that manages content, a command to process the content, the route certificate data for verifying server certificate data of the server device to an external device on the network via the communication unit.

2. The communication apparatus according to claim 1, wherein, at the time of supplying the route certificate data to the external device, the processing unit gives a command to acquire the route certificate data to the external device in advance, and supplies the route certificate data to the external device after receiving a request signal corresponding to the acquisition command from the external device.

3. The communication apparatus according to claim 1, wherein the processing unit gives only the address information and the processing command to the external device in advance, and supplies the route certificate data to the external device after a notice that an error is brought about at the time of authentication processing of the server certificate of the server device is given from the external device.

4. The communication apparatus according to claim 1, wherein the processing unit supplies the route certificate data to the external device only when the address information of the server device starts with https.

5. The communication apparatus according to claim 1, wherein the processing unit supplies to the external device a command to form an image onto a recording medium which corresponds to image information of the content.

6. A communication apparatus comprising:
a communication unit which makes communication via a network;
an execution unit which executes information processing on the basis of content to be provided; and
a processing unit which, when address information of a server device that manages content, a command to process the content, and route certificate data for verifying server certificate data of the server device are received from a communication apparatus on the network via the communication unit, accesses the server device on the Internet shown by the address information via the communication unit, receives the server certificate data from the server device, and determines whether or not the server certificate data is authentic on the basis of the route certificate; and when it is determined to be authentic, acquires the content from the server device, and causes the execution unit to execute information processing on the basis of the acquired content.

7. The communication apparatus according to claim 6, wherein the processing unit makes control to receive the route certificate data from the external device by receiving a command to acquire the route certificate data from the external device, and transmitting a request signal corresponding to the command to the external device.

8. The communication apparatus according to claim 6, wherein the processing unit makes control to receive the route certificate data from the external device by reporting to the external device that a result of authentication processing of a server certificate after accessing the server device in accordance with the processing command from the external device is made to be in error.

9. The communication apparatus according to claim 6, wherein the processing unit receives from the external device a command to form an image on a recording medium which corresponds to image information of the content.

10. A communication method which is carried out between a first communication apparatus and a second communication apparatus provided on a network, the method comprising:
in the first communication apparatus, supplying address information of a server device that manages content, a command to process the content, the route certificate data for verifying server certificate data of the server device to the second communication apparatus on the network; and
in the second communication apparatus, upon receipt of the address information of the server device, the command to process the content, and the route certificate data from the first communication apparatus, accessing a server device on the Internet shown by the address information, receiving the server certificate data from the server device, and determining whether or not the server certificate data is authentic on the basis of the route certificate data; and when it is determined to be authentic, acquiring the content from the server device, and carrying out information processing on the basis of the acquired content.

11. The communication method according to claim 10, wherein the route certificate data is supplied from the first communication apparatus to the second communication apparatus only when the address information of the server device starts with https.

12. The communication method according to claim 10, wherein, when, in the second communication apparatus, it is determined that the server certificate data is authentic, the content is acquired from the server device, and an image is formed onto a recording medium in accordance with image information of the content.
